(19) United States
(12) Patent Application Publication
(10) Pub. No.: US 2010/0302212 A1
(43) Pub. Date: Dec. 2, 2010

(54) TOUCH PERSONALIZATION FOR A DISPLAY DEVICE

(75) Inventors: Karon Weber, Kirkland, WA (US); Jeffrey Ort, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/476,863

(22) Filed: Jun. 2, 2009

(51) Int. Cl. G06F 3/041

(52) U.S. Cl. 345/178

(57) ABSTRACT

A computing device includes a touch display, a collection module, a characterization module, and an adjustment module. The collection module is configured to identify one or more touch attributes of an input tool interacting with the touch display. Each such touch attribute represents an interaction characteristic of the input tool with the display. The characterization module is configured to generate a touch map based on the one or more touch attributes. The adjustment module is configured to set one or more input-receiving parameters of an interface displayed on the touch display based on the touch map.

### BACKGROUND

Devices that operate with natural user interfaces have become increasingly popular in recent times. The interface enhances the user's experience by enabling the user to directly manipulate the device using a finger or other input tool. The interface of such a device is often developed to respond to the touch of an “average” finger. However, due to wide variations in finger sizes and other finger attributes, user interactions with the device may be error-prone, and the end-user experience may be unsatisfactory.

### SUMMARY

Touch personalization for a display device is disclosed. One example embodiment includes a touch display, a collection module, a characterization module, and an adjustment module. The collection module may be configured to identify one or more touch attributes of an input tool interacting with the touch display, each touch attribute representing an interaction characteristic of the input tool with the display. The characterization module may be configured to generate a touch map based on the one or more touch attributes. The adjustment module may be configured to set one or more input-receiving parameters of an interface displayed on the touch display based on the touch map.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically illustrates an exemplary system for touch-personalization of a computing device coupled to a network-accessible server.

FIG. 2 illustrates a calibration step that may be performed in a touch display device to generate a user-specific touch map, in accordance with an embodiment of the present disclosure.

FIGS. 3A and 3B illustrate adjustments to an interface of a touch display device responsive to a user finger size.

FIGS. 4-5 illustrate adjustments to input-receiving parameters of an interface displayed on a touch display device.

### DETAILED DESCRIPTION

Touch personalization of a computing device, such as a touch display device, is disclosed herein. Based on different touch attributes of a user-specific input tool, such as a user finger, a touch interface of the touch display device may be adjusted. As a non-limiting example, the interface may be differently adjusted when the user's finger is small and narrow versus when the user's finger is large and broad. As described in more detail below, by adaptively learning from touch interactions between the user's finger and the touch display device, and by dynamically updating the device's touch interface accordingly, the user's experience with the device is enhanced.

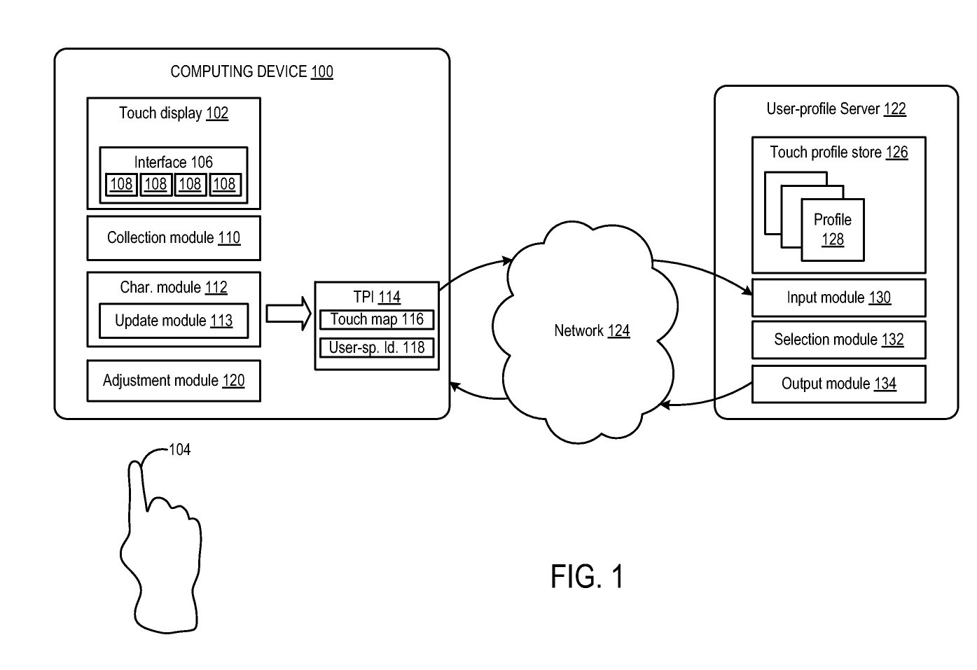

FIG. 1 schematically shows a system for personalizing a touch display device for one or more different input tools. In particular, FIG. 1 shows a computing device 100. In the depicted example, the computing device 100 is a touch display device including a touch display 102. A user may operate the computing device 100 by touching the touch display 102 with an input tool 104. In the depicted example, the input tool 104 is in the form of a user index finger. However, it will be appreciated that other forms of input tools may also be used. These may include, for example, other fingers (such as a thumb), alternate body parts, or mechanical input tools (such as a stylus).

An interface 106 is displayed on touch display 102. The interface 106 may include one or more interface elements 108. The interface may be configured to recognize touch input from one or more fingers or other input tools (i.e., single-touch or multi-touch input). The interface may also be configured to recognize different kinds of touch input. Non-limiting examples of such touch inputs include a single tap, multiple taps, a stroke, or a gesture.

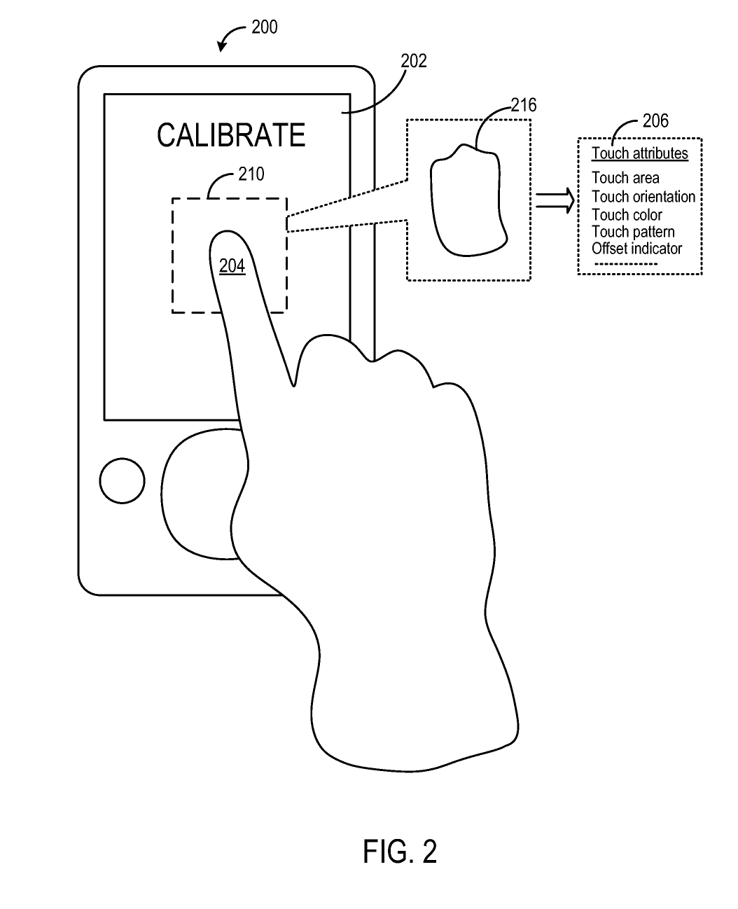

Computing device 100 includes a collection module 110 configured to identify one or more touch attributes of the input tool 104 interacting with the touch display 102. As further elaborated with reference to FIG. 2, the touch attributes may represent different interaction characteristics of the input tool 104 with the touch display 102.

Computing device 100 also includes a characterization module 112. As further elaborated with reference to FIG. 2, the characterization module 112 is configured to generate a touch profile indicator 114 (TPI) based on the input tool touch attributes identified and collected by the collection module 110. In some scenarios, the touch profile indicator 114 may include a touch map 116. For example, the touch profile indicator 114 may include one or more touch maps 116 corresponding to one or more input tools 104 (such as one or more fingers) commonly used by the user to operate the computing device 100. In some scenarios, the touch profile indicator 114 may include a user-specific identifier 118. For example, the touch profile indicator may include a user-specific login name, a user-specific code, or other user-specific identification data.

The characterization module 112 may include an update module 113 configured to dynamically update the touch map based on continuous interactions of the input tool 104 with the touch display 102. That is, with every touch interaction of each input tool 104 with the touch display 102, the characterization module 112 may update and refine the contours and boundaries of the corresponding touch map 116.

The characterization module may also be configured to set a touch focus of the input tool based on the one or more touch attributes collected by the collection module 220. The touch focus may represent a focal point of the touch map. In one example, the focal point may also be a center point of the touch map. In another example, the position of the focal point may be weighted based on the various touch attributes associated with the corresponding input tool.

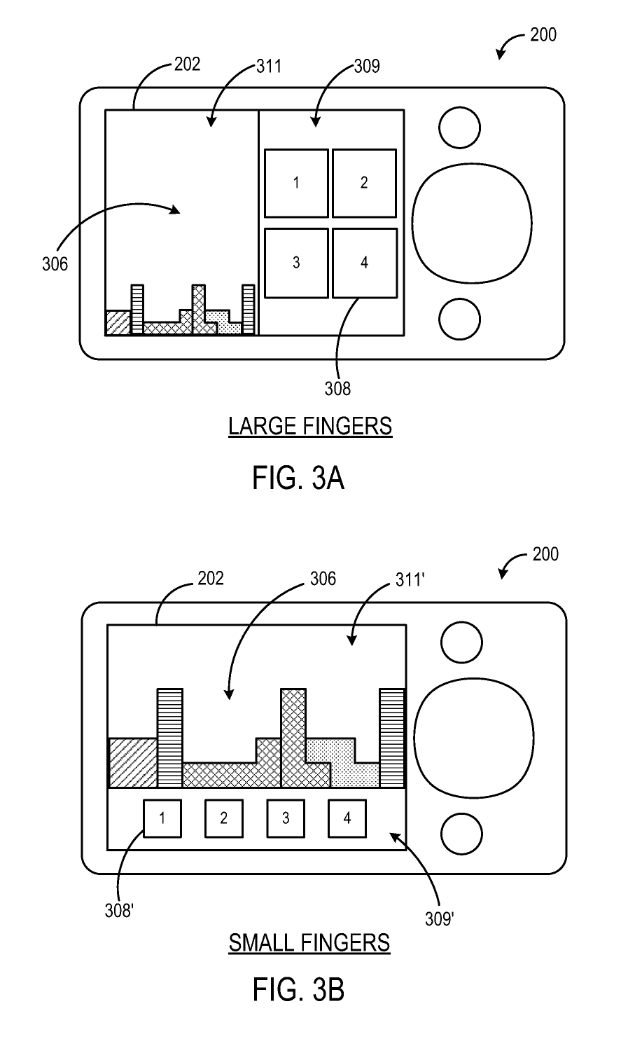

The computing device 100 further includes an adjustment module 120 configured to set one or more input-receiving parameters of the interface 106 displayed on the touch display 102 based on the touch map 116 generated by the characterization module 112. As further elaborated with reference to FIGS. 3-5, by adjusting the input-receiving parameters, different aspects of the interface elements 108 may be adjusted responsive to the user's touch map 116. The adjusted interface 106 may improve the user's touch experience with the computing device, for example, by reducing mistypes and other touch-related errors. The adjustment module 120 further dynamically updates settings of the one or more input-receiving parameters based on continued interactions of the input tool 104 with the one or more interface elements 108 of the interface 106 displayed on the touch display 102. The adjustment module 120 can be part of one or more applications and/or part of an operating system. In other words, a particular application may make interface adjustments independently, or a system may make adjustments for one or more applications on behalf of such applications.

The adjustment module(s) may be configured to make adjustments for a particular application, a particular website, or virtually any other particular context. As a nonlimiting example, a user's favorite news site may provide a personalized interaction model and controls. That is, a user may use a personalized touch map to enhance the experience when using that user's favorite news site. The news site may heavily utilize reading, clipping, and annotating controls. As such, the adjustment module for that site may be configured to interpret the touch profile to make a highlighting/annotation tool the right thickness based on the user's finger size. Similarly, the user's clipping tool, which uses the pinch and stretch gesture, may be customized to the reach of the user's fingers.

In some embodiments, an adjustment module 120 may make adjustments in consideration of the touch characteristics of a particular device. For example, a device with a five inch screen may interpret a touch profile differently than a device with a three inch screen.

One or more computing device 100 may be connected to a user-profile server 122 via a network 124, such as the Internet. The user-profile server 122 may comprise a touch profile store 126 including one or more touch profiles 128. Each of the one or more touch profiles may include information useable by a computing device to set one or more input-receiving parameters of the interface 106 displayed on its touch display 102. Each touch profile 128 may include information associated with a corresponding user. As one example, a touch profile 128 may include a user-specific identity, such as user-specific login name. As another example, a touch profile 128 may include one or more user-specific touch maps 116 corresponding to one or more commonly used user input tools (such as one or more commonly used fingers). Additionally, the touch profile 128 may include combinations of user-specific identities and touch maps.

In this way, information that can be used to enhance a user's experience with a device can be made accessible, via a network, to a variety of different user devices. Furthermore, various different profiles may be saved and made accessible, via a network, to a single user, so that the experience for that user can be customized for a particular public or private device, a particular application, a particular website, or virtually any other particular context. In this way, based on the identity of a user, a device may retrieve an appropriate profile from the network so that the user's experience may be enhanced for the scenario in which the user is currently operating.

The user-profile server 122 includes an input module 130 configured to receive a touch-profile indicator 114 from a computing device 100 to help identify the user. A selection module 132 of the user-profile server 122 may then select a touch profile 128 from the touch profile store 126 based on the received touch-profile indicator 114. In one scenario, when the touch profile indicator 114 includes a user-specific identifier, the selection module 132 may select a touch profile 128 by matching the user-specific identifier with a user-specific identity associated with a touch profile 128 in the touch profile store 126. In one example, an exact match may be required to correctly identify the user.

In another scenario, when the touch profile indicator 114 includes a touch map, the selection module 132 selects a touch profile 128 by comparing the touch map with one or more touch profiles 128 included in the profile store 126 and determining a match value between the touch map and each of the one or more touch profiles 128. The selection module 132 may then choose a touch profile based on the match value. The match value may be compared to a match threshold value. In one example, if the match value is above the match threshold value, an exact match may be determined. In another example, if the match value is below the match threshold value, an exact match may not be determined and the selection module may, instead, offer a “best-guess” touch profile (that is, a match with the highest match value). Alternatively, the selection module may offer a “generic” touch profile. For example, the selection module may determine that the touch map associated with the queried touch profile indicator 114 includes touch attributes for a left-handed user with relatively small-sized fingers. Accordingly, the selection module may select a generic “left-handed small finger” touch profile.

Upon selection of a touch profile 128 by the selection module 132, an output module 134 of the user-profile server 122 may be configured to send the selected touch profile 128 to the computing device 100. Upon receiving the touch profile 128 from the user-profile server 122, the settings of the interface 106 of the computing device 100 may be adjusted responsive to the received touch profile 128 and its included touch map.

In some embodiments, a local touch profile store may be included as part of computing device 100. In such embodiments, computing device 100 may select a touch profile from a plurality of locally available touch profiles without accessing a remote touch profile store via a network.

The systems described herein may be tied to a variety of different computing devices. The examples shown in the following figures are directed towards a computing device in the form of a mobile touch-display device. However, a variety of different types of touch computing devices may be used without departing from the scope of this disclosure. While FIGS. 2-5 use a mobile touch display device to illustrate concepts of touch personalization, it will be appreciated that the depicted scenario is not meant to be limiting in any way. On the contrary, the illustrated touch display device and related touch personalization is intended to demonstrate a general concept, which may be applied to a variety of different applications and computing devices without departing from the scope of this disclosure.

FIG. 2 schematically illustrates a calibration step that may be performed by a computing device to enable a user-specific touch personalization of the device. In one example, the calibration may be performed when a user initiates operation of a touch display device 200, for example by turning on the device or by touching the device. The calibration step enables the touch display device 200 to generate a touch map 216 corresponding to an input tool used during the calibration step, herein user finger 204, and hence corresponding to a specific user touching the touch display 202 during the calibration step, and enables the touch display device settings to be adjusted accordingly. During calibration, the user may be requested to apply the input tool to the touch display 202 so that the characterization module may be able to generate a touch map 216 corresponding to the input tool. In the depicted example, at calibration, the user is requested to touch the touch display 202, specifically within target 210, using the selected user finger 204. The collection module may then identify and collect touch attributes 206 representing interaction characteristics 208 of the user finger 204 with the touch display 102.

As such, the nature of the interaction characteristics 208, and consequently touch attributes 206, may be largely affected by the nature of the input tool selected. In one scenario, as depicted, when the input tool is a user finger 204, the interaction of the user finger 204 with the touch display 202 may be affected by the handedness of the user (for example, whether the user is left-handed or right-handed). The handedness of the user may affect, for example, a tilt or orientation with which the user touches the user finger 204 on the touch display 202. Similarly, the handedness may affect, for example, the touch area of the user finger 204 that makes contact with the touch display 202. Furthermore, the attributes may change based on which finger (for example, index finger versus thumb) the user selects as the input tool, as well as the number of fingers the user selects as the input tool (for example, left index finger versus left and right thumbs).

The interaction characteristics 208 collected by a collection module of the touch display device 200 may include, for example, a touch area, that is, a section of the touch display 202 that the user finger 204 actually makes contact with. In another example, the interaction characteristics 208 may include a touch orientation, that is, an angle at which the user finger 204 touches the touch display 202. In yet another example, the interaction characteristics 208 may include a touch color, that is, a tint of the user finger 204 that makes contact with the touch display 202. In still another example, the interaction characteristics 208 may include a touch pattern.

Interaction characteristics may also include an offset indicator that represents a difference (e.g., magnitude and direction) between a location where a touch input is actually resolved by a touch display and a location of a target that the user was asked to touch. Such an offset indicator may be used to adjust a touch focus of the input tool so that the location to which a touch display resolves a touch input closely corresponds to the location that the user intends to touch.

The touch attributes 206, reflective of the various interaction characteristics 208, may be observed and/or inferred based on vision, capacitance, resistance, and/or other properties, depending on the technology used by the touch display 202 to recognize the touch input. In the depicted example, where the user is requested to touch target 210 with the selected user finger 204, the touch attributes 206 are observed relative to the shown target 210 so that variances in touch can be accounted for and a user-specific touch map 216 may be accordingly generated. In one scenario, when using a right-hand index finger as the input tool, the user may tend to touch the target 210 with a left-tilt. Furthermore, the touch area may be relatively small. In another scenario, when using a left hand thumb as the input tool, the user may tend to touch the target 210 with a right-tilt, and with a relatively large touch area.

The characterization module generates a touch map 216, which is schematically shown and corresponds to the user finger 204 based on the touch attributes 206 received. An initial touch map may be generated during calibration. Then, during the course of touch display device 200 operation by the user, the characterization module may optionally dynamically update the initial touch map based on continued interactions of the user finger 204 with the touch display 202. As previously elaborated with reference to FIG. 1, an update module may be configured to update the touch map based on the continued interactions to enable the touch map to be refined with every subsequent touch or only with selected subsequent touches. While the depicted scenario illustrates the generation of touch map 216 during a calibration step, the scenario is not meant to be limiting in any way. The touch map 216 may alternatively be generated without a calibration step, for example, during normal device operation.

FIGS. 3A and 3B illustrate examples wherein the interface 306 of touch display device 200 is adjusted responsive to an input tool touch attribute, specifically a user finger touch area. In some embodiments, the interface may be adjusted based on alternate or additional touch attributes.

In the example scenario shown in FIG. 3A, a touch map indicative of a large finger may be generated by the characterization module responsive to the detection of a large finger. The adjustment module may increase the size of interface elements 308 displayed on interface 306 in accordance with the larger finger touch map. While increasing the size of the interface elements 308, the portion 309 of touch display 202 occupied by interface 306 may also be increased, while a portion 311 of touch display 202 occupied by interface 306 may be correspondingly decreased. By adjusting (herein, enlarging) the interface elements 308 to better suit the touch attributes of the larger user finger, touch related errors such as mistypes and selection ambiguities may be substantially reduced, and the end-user experience may be enhanced.

In the example scenario shown in FIG. 3B, a touch map indicative of a small finger may be generated by the characterization module responsive to detection of a small finger. The adjustment module may then decrease the size of interface elements 308′ displayed on interface 306 in accordance with the smaller finger touch map. While decreasing the size of the interface elements 308′, the portion 309′ of touch display 202 occupied by interface 306 may also be decreased, while a portion 311′ of touch display 202 occupied by interface 306 may be correspondingly increased. The smaller sized interface elements 308′ may be adjusted to a size small enough to comfortably accommodate the smaller fingers while large enough to avoid mistypes, selection ambiguities, and related touch errors. At the same time, the end-user experience is further enhanced by the provision of a larger display region where the data input by the smaller finger is more noticeably displayed.

In some embodiments, the interface 306 may be additionally or optionally adjusted based on an orientation of the touch display device 200. For example, when the touch display device is in a vertical orientation, the touch display device may be more likely to be operated with a single input tool (such as a single index finger). In contrast, for example, when the touch display device is in a horizontal orientation, the touch display device may be more likely to be operated with multiple input tools (such as two thumbs). The characterization module may have generated one or more touch maps based on the touch attributes of the one or more user fingers selected by the user for use as the input tool(s). The adjustment module may be configured to select a touch map based on the orientation of the touch display device and set the input-receiving parameters displayed on the interface of the touch display device in accordance with the chosen touch map(s).

In one example scenario, the characterization module may have generated a dominant right-finger touch map and right and left thumb touch maps. When the touch display device is determined to be in a horizontal orientation, that is, when the touch display device is likely to be used with a left and right thumb, the adjustment module may be configured to adjust the left portion of the interface based on the left-thumb touch map while adjusting the right portion of the interface based on the right-thumb touch map.

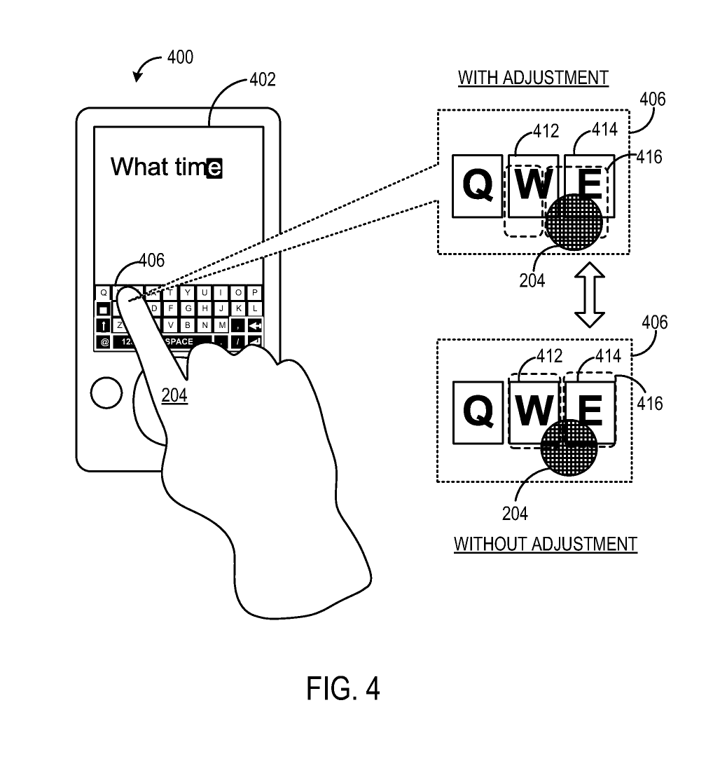

In contrast, when the touch display device is determined to be in a vertical orientation, that is, when the touch display device is likely to be used with a dominant right-finger, the adjustment module may be configured to adjust the interface based on the touch map of the dominant right-finger, or the most commonly selected finger. As further elaborated with reference to FIG. 4, the interface and interface elements may be adjusted by adjusting settings for one or more input-receiving parameters of the interface based on the user-specific touch map.

While the above are provided as nonlimiting example interface adjustments that can be used to tailor an interface to a particular touch profile, it is to be understood that virtually all other customizations are within the spirit of this disclosure. As another example, completely different versions of various controls may be chosen based on a touch profile. For example, five separate buttons representing five separate options may be displayed for a user with a small finger, whereas a single selection wheel with five options may be displayed for a user with a large finger. In such an example, both users have access to the same options, although the user with the smaller finger, who can more accurately press smaller buttons, has more direct access, thus enhancing that user's experience. At the same time, the user with the larger finger has a larger control to interact with, thus decreasing mistypes and accidental selections, thus enhancing that user's experience.

FIG. 4 illustrates other non-limiting example adjustments to various input receiving parameters of an interface 406 displayed on a touch display 402 of touch display device 400, responsive to touch attributes of a user finger 204. The adjustments may enable a reduction in the number of touch-related errors that may occur during the user's operation of the touch display device.

In the depicted example, the user finger 204 may have been mapped, such as during a previous calibration step, and a corresponding touch map may have been generated. Furthermore, interaction characteristics specific to the user finger 204 may have been previously determined. For example, it may have been determined that the user finger 204 generates a touch map with a downward and leftward offset. Based on a touch history of the user finger 204, it may also be known that when interacting with interface 406, the user finger 204 tends to inadvertently touch interface element W 412 when intending to touch adjacent interface element E 414. Consequently, when interface 406 displays a keyboard, the user tends to mistype a W when intending to type an E. To reduce such mistyping errors, the settings of the input-receiving parameters of the interface elements may be adjusted, in accordance with the user's touch map and/or the user's touch history. In some examples, the input receiving parameters may include a hit-target size of the interface elements. In some examples, the input receiving parameters may include a hit-target offset of the interface elements.

In the depicted example, when an adjustment has been performed, based on the known downward and leftward offset of the touch map, and/or based on the touch history of the user, the size of hit-target 416 for interface element E 414 may be increased while the size of hit-target 416 for adjacent interface element W 412 may be decreased. Additionally, the hit-target 416 for the interface elements 414 and 412 may be shifted left and low, such that the hit-target for interface element E 414 may overlap a portion of the display of interface element W 412. The adjustments enable the touch display device to account for variances in the user finger's interaction with the different interface elements. In contrast, when unadjusted, the hit-target 416 for interface element W 412 and interface element Q 414 may be of the same size and without an offset, such that the user may continue to mistype W when intending to type an E. By adjusting settings for the hit-target size, offset, and other related input-receiving parameters of the interface elements based on the user's touch map, the touch display device can preempt such typing errors.

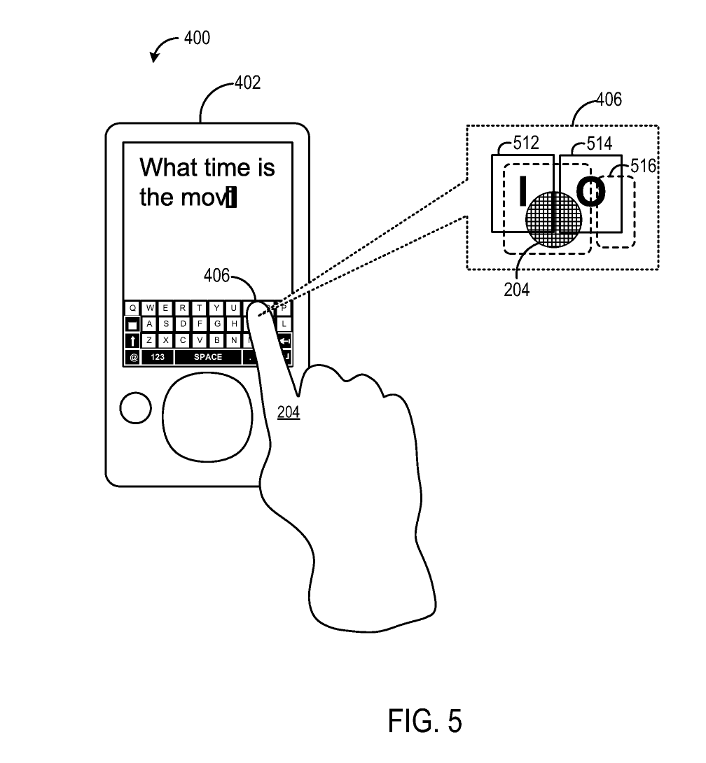

FIG. 5 illustrates another non-limiting example of adjustments to input receiving parameters of an interface 406 displayed on a touch display 402 of touch display device 400, responsive to touch attributes of a user finger 204. Specifically, the example illustrates predictive adjustments that may be performed to reduce the number of touch-related errors that may occur during the user's operation of the touch display device.

In the depicted example, as in FIG. 4, the user finger 204 may have been mapped during a previous calibration step, and a corresponding touch map may have been generated. Furthermore, interaction characteristics specific to the user finger may have been determined. For example, it may have been determined that the user finger 204 generates a touch map with a rightward and downward offset. Based on the application in use on the touch display device 400, a context-based touch interaction may be predicted and interface element settings may be accordingly adjusted, with consideration being given to touch personalizations available via the touch map.

In the depicted scenario, a word-processing application may be in use on the touch display device 400 and interface 406 may be displaying a keyboard. Herein, the most recent touch interaction between user finger 204 and interface 406 was for typing the letter V. Based on predictive abilities of the touch display device 400, and based on the context of the word typed so far (that is, MOV), it may be predicted that the following letter is more likely to be an interface element 1512 than the neighboring interface element O 514. With this predictive information, the settings of the input-receiving parameters of the interface elements may be adjusted, in accordance with the user's touch map. Based on the known rightward and downward offset of the touch map, and further based on the predicted information, the size of hit-target 516 for interface element 1512 may be increased while the size of hit-target 516 for adjacent interface element O 514 may be decreased. Additionally, the hit-target 516 for the interface elements may be offset right and low, such that the hit-target for interface element 1512 may overlap a portion of the display of interface element O 514. By adjusting settings for the hit-target size, offset, and other related input-receiving parameters of the interface elements based on the user's touch map and based on predictive abilities, the touch display device can preempt typing errors.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computing device, comprising:
a touch display;
a collection module configured to identify one or more touch attributes of an input tool interacting with the touch display, each touch attribute representing an interaction characteristic of the input tool with the display;
a characterization module configured to generate a touch map based on the one or more touch attributes; and
an adjustment module configured to set one or more input-receiving parameters of an interface displayed on the touch display based on the touch map.

2. The computing device of claim 1, wherein the input receiving parameters include a hit-target size of an interface element of the interface displayed on the touch display.

3. The computing device of claim 1, wherein the input receiving parameters include a hit-target offset of an interface element of the interface displayed on the touch display.

4. The computing device of claim 1, where the characterization module sets a touch focus of the input tool based on the one or more touch attributes.

5. The computing device of claim 1, wherein the adjustment module is further configured to dynamically update settings of the one or more input-receiving parameters based on continued interactions of the input tool with one or more interface elements of the interface displayed on the touch display.

6. The computing device of claim 1, wherein the interaction characteristic includes a touch area.

7. The computing device of claim 1, wherein the interaction characteristic includes a touch orientation.

8. The computing device of claim 1, wherein the interaction characteristic includes an offset indicator.

9. The computing device of claim 1, wherein the interaction characteristic includes a touch pattern.

10. The computing device of claim 1, wherein the characterization module is further configured to dynamically update the touch map based on continued interactions of the input tool with the touch display.

11. The computing device of claim 1, where the input tool is a user finger.

12. A network-accessible user-profile server coupled with one or more touch display devices via a network, the server comprising:
a touch profile store including one or more touch profiles, each of the one or more touch profiles including information useable by a touch display device to set one or more input-receiving parameters of an interface displayed on the touch display device;
an input module configured to receive a touch-profile indicator from the touch display device;
a selection module configured to select a touch profile from the touch profile store based on the touch-profile indicator; and
an output module configured to send the selected touch profile to the touch display device.

13. The server of claim 12, wherein the touch-profile indicator includes a user-specific identifier.

14. The server of claim 13, wherein the selection module selects a touch profile by matching the user-specific identifier with a user-specific identity associated a touch profile in the touch profile store.

15. The server of claim 12, wherein the touch-profile indicator includes a touch map.

16. The server of claim 15, wherein the selection module selects a touch profile by comparing the touch map with one or more touch profiles included in the touch profile store, determining a match value between the touch map and the one or more touch profiles, and choosing a touch profile based on the match value.

17. A computing system, comprising:
a touch display device;
a collection module configured to identify one or more touch attributes of a user finger interacting with the touch display device, the one or more attributes including a touch-area size and a touch-area orientation;
a characterization module configured to generate a touch map based on the one or more touch attributes;
an adjustment module configured to set one or more input-receiving parameters, including a hit-target area of an interface element displayed on an interface of the touch display device, based on the touch map; and
an update module configured to dynamically update the touch map based on interactions of the user finger with the interface displayed on the touch display device.

18. The computing system of claim 17, wherein the adjustment module is further configured to dynamically update settings of the one or more input-receiving parameters based on continued interactions of the input tool with one or more interface elements of the interface displayed on the touch display.

19. The computing system of claim 17, wherein the characterization module is configured to generate one or more touch maps based on the touch attributes of one or more user fingers and the adjustment module is configured to select a chosen one of the one or more touch maps based on an orientation of the touch display device, and set the input-receiving parameters displayed on the interface of the touch display device in accordance with the chosen one of the one or more touch maps.

20. The computing system of claim 17, wherein the characterization module is configured to generate a left finger touch map based on the touch attributes of a user left finger and a right finger touch map based on the touch attributes of a user right finger, and the adjustment module is configured to set the input-receiving parameters displayed on the left portion of the touch display device in accordance with the left finger touch map, and set the input-receiving parameters displayed on the right portion of the touch display device in accordance with the right finger touch map.
